(19) United States
(12) Patent Application Publication
(10) Pub. No.: US 2011/0274951 A1
(43) Pub. Date: Nov. 10, 2011

(54) BATTERY MODULE AND BATTERY MODULE ASSEMBLY USING SAME

(76) Inventors: Shunsuke Yasui, Osaka (JP); Takuya Nakashima, Osaka (JP)

(21) Appl. No.: 13/143,877

(22) PCT Filed: Feb. 23, 2010
(86) PCT No.: PCT/JP2010/001172

§ 371 Date: Jul. 8, 2011

(30) Foreign Application Priority Data
Feb. 24, 2009 (JP) 2009-040790

(51) Int. Cl. H01M 2/10; H01M 2/12

(52) U.S. Cl. 429/53; 429/99

(57) ABSTRACT

A battery module includes a battery unit, a housing, a lid, and a heat-absorbing member. The battery unit includes two or more battery cells. The housing includes a storage part having an open end on at least one surface, and the storage part stores the battery unit. The lid has an opened part, and covers the open end of the housing. The heat-absorbing member is provided in contact with each side surface of each battery unit, and encloses heat-absorbing agent made of liquid or gel fluid.

### TECHNICAL FIELD

The present invention relates to a battery module in which even if failure such as heat generation occurs in one of a plurality of battery cells constituting a battery unit does not affect surrounding battery cells, and to a battery module assembly using the battery module.

### BACKGROUND ART

Recently, from the viewpoint of resource savings and energy savings, secondary batteries such as nickel hydrogen storage battery, nickel cadmium storage battery and lithium ion secondary battery, which can be used repeatedly, have been increasingly demanded. Among them, the lithium ion battery has features including light weight, high electromotive force, and large energy density. Therefore, there is an increasing demand for lithium ion secondary batteries as driving power supplies for various types of portable electronic apparatuses and mobile telecommunication apparatuses such as portable telephones, digital cameras, video cameras, and notebook-sized personal computers.

On the other hand, in order to reduce the amount of fossil fuel to be used and amount of CO₂ emissions, a battery module as a power supply for driving a motor of an automobile or the like is increasingly expected. The battery module is formed of battery units each including two or more battery cells in order to obtain a desired voltage or capacity.

As the capacity of a battery cell is increased, the battery cell itself may generate heat and have a high temperature depending on the mode of use. Therefore, in addition to the safety of a battery cell, the safety of a battery unit that is made by assembling a plurality of the battery cells and the safety of a battery module that is made by combining a plurality of battery units become more important.

In a battery cell, an internal pressure rises due to gas generated by overcharge, overdischarge, internal short-circuit or external short-circuit, and occasionally, an outer case of the battery cell may be ruptured. Therefore, in general, the battery cell is provided with a vent mechanism for venting gas, a safety valve, or the like. With such a configuration, internal gas is released.

However, there are problems to be solved in reliability and safety because an exhausted gas may ignite, so that the gas may produce smoke, or, although rarely, catch fire. In particular, in a battery unit formed by integrating a plurality of battery cells, there is high possibility that abnormal heat generation of one battery cell may cause abnormal heating or fire in surrounding battery cells, thereby inducing failures successively. Therefore, it is important to prevent such successive failures. Thus, a fire-extinguishing agent provided in a battery pack (see, for example, Patent Literature 1) and a configuration for ejecting a fire-extinguishing agent into a battery pack from the outside (see, for example, Patent Literature 2) are proposed.

According to Patent Literature 1, a fire-extinguishing agent provided in the lower side in a battery pack is ejected by a gas pressure generated in a battery at an abnormal state. However, such a configuration hinders the miniaturization of a battery pack. Furthermore, when a plurality of battery cells are integrated, it is not possible to prevent an abnormally heat-generated cell from conducting heat to surrounding cells to cause successive heat generation.

According to Patent Literature 2, a fluorine inactive liquid is ejected in a battery module at an abnormal state of battery module. The evaporative latent heat thereof lowers the temperature of a battery cell with failure to the evaporating temperature of the fluorine inactive liquid so as to extinguish a fire. However, also in such a configuration, there is a problem in miniaturizing a battery module. Furthermore, since the fluorine inactive liquid has the evaporation temperature of 400° C., it cannot be used for lithium ion batteries and the like.

### CITATION LIST

### Patent Literature

Patent Literature 1: Japanese Patent Application Unexamined Publication No. H9-161754
Patent Literature 2: Japanese Patent Application Unexamined Publication No. H4-286874

### SUMMARY OF THE INVENTION

The present invention provides a battery module capable of being reduced in size, suppressing the effect of abnormal heat generation of a battery cell with failure on surrounding battery cells to minimum and a battery module assembly using the battery module. The battery module of the present invention includes a battery unit composed of two or more of battery cells, a housing, a lid, and a heat-absorbing member. The housing includes a storage part having an open end on at least one surface, and the storage part stores the battery unit. The lid covering the open end of the housing has an opened part. The heat-absorbing member includes heat-absorbing agent formed of liquid or gel fluid and an outer film enclosing the heat-absorbing agent, and is in contact with a side surface of the battery unit.

With this configuration, the heat abnormally generated from a battery cell with failure is absorbed by the heat-absorbing agent, and thus, successive occurrence of failure in the surrounding battery cells due to heat transfer can be prevented. Furthermore, since the heat-absorbing member is provided in contact with each battery cell, the battery unit can be reduced in size. Moreover, the heat abnormally generated from a battery cell with failure can be transferred to the heat-absorbing member for a short time, and thus fire caused due to heat generation or ignition can be suppressed effectively. As a result, a battery module having a smaller size, higher safety, and more excellent reliability can be achieved. In addition, the battery module assembly of the present invention has a configuration in which a plurality of the battery modules are combined by at least any of serial connection and parallel connection. With this configuration, depending upon the application of use, it is possible to achieve a battery module assembly having arbitrary voltage and capacity and having high safety.

### BRIEF DESCRIPTION OF THE DRAWINGS

FIG. 1 is a longitudinal sectional view of a battery cell constituting a battery unit of a battery module in accordance with a first exemplary embodiment of the present invention.

FIG. 2A is a perspective view of the battery module in accordance with the first exemplary embodiment of the present invention.

FIG. 2B is a sectional view taken along line 2B-2B of the battery module shown in FIG. 2A.

FIG. 2C is a sectional view of a principal part of a heat-absorbing member used in the battery module in accordance with the first exemplary embodiment of the present invention.

FIG. 3 is an exploded perspective view of the battery module in accordance with the first exemplary embodiment of the present invention.

FIG. 4A is a sectional view illustrating a state in which abnormal heat generation occurs in one of the battery cells in the battery module in accordance with the first exemplary embodiment of the present invention.

FIG. 4B is an enlarged sectional view of part 4B in FIG. 4A.

FIG. 5A is a perspective view of another battery unit in accordance with the first exemplary embodiment of the present invention.

FIG. 5B is a top view of the battery unit shown in FIG. 5A.

FIG. 6A is a perspective view of a heat-absorbing member used in another battery unit in accordance with the first exemplary embodiment of the present invention.

FIG. 6B is a top view of a battery unit using the heat-absorbing member shown in FIG. 6A.

FIG. 7A is a perspective view of a battery module in accordance with a second exemplary embodiment of the present invention.

FIG. 7B is a sectional view taken along line 6B-6B of the battery module shown in FIG. 7A.

FIG. 8 is an exploded perspective view of the battery module shown in FIG. 7A.

FIG. 9A is a perspective view of a battery unit used in the battery module shown in FIG. 7A.

FIG. 9B is a top view of the battery unit shown in FIG. 9A.

FIG. 10A is a sectional view illustrating a state in which abnormal heat generation occurs in one of battery cells in the battery module in the second exemplary embodiment of the present invention.

FIG. 10B is an enlarged sectional view of part 9B in FIG. 10A.

FIG. 11A is a perspective view of another battery unit in accordance with the second exemplary embodiment of the present invention.

FIG. 11B is a top view of the battery unit shown in FIG. 11A.

FIG. 12A is a perspective view of still another battery unit in accordance with the second exemplary embodiment of the present invention.

FIG. 12B is a top view of the battery unit shown in FIG. 12A.

FIG. 12C is a top view of a heat-absorbing member used in the battery unit shown in FIG. 12A.

FIG. 13A is a perspective view of yet another battery unit in accordance with the second exemplary embodiment of the present invention.

FIG. 13B is a top view of the battery unit shown in FIG. 13A.

FIG. 13C is a perspective view of a spacer used in the battery unit shown in FIG. 13A.

FIG. 14A is a perspective view of a battery module assembly in accordance with a third exemplary embodiment of the present invention.

FIG. 14B is a perspective view of another battery module assembly in accordance with the third exemplary embodiment of the present invention.

FIG. 15 is an exploded perspective view of still another battery module assembly in accordance with the third exemplary embodiment of the present invention.

### DETAILED DESCRIPTION OF THE PREFERRED EMBODIMENTS

Hereinafter, exemplary embodiments of the present invention are described with reference to drawings in which the same reference numerals are given to the same components. Note here that the present invention is not limited to the contents mentioned below as long as it is based on the basic features described in this specification. Furthermore, in the below description, a non-aqueous electrolyte secondary battery such as a lithium ion battery (hereinafter, referred to as a “battery cell”) is described as an example of a battery cell. However, the present invention is not limited to this example.

### First Exemplary Embodiment

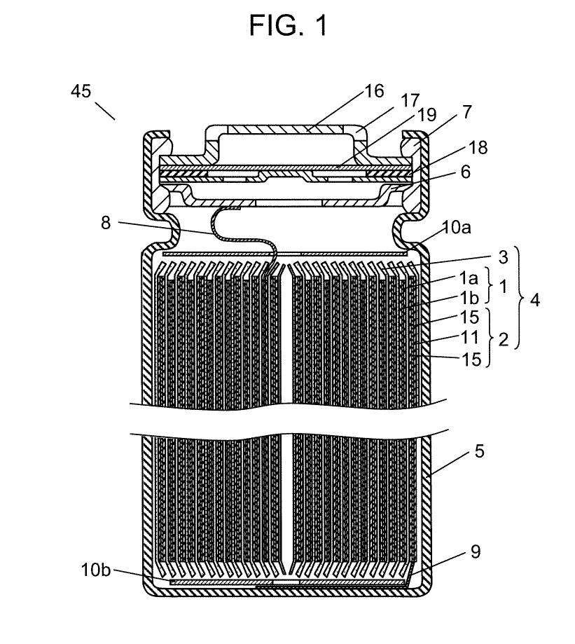

FIG. 1 is a longitudinal sectional view of a cylindrical battery cell constituting a battery unit of a battery module in accordance with a first exemplary embodiment of the present invention. Battery cell 45 includes electrode group 4. Electrode group 4 is formed by winding positive electrode 1 and negative electrode 2 facing positive electrode 1 with separator 3 interposed therebetween. Lead 8 made of, for example, aluminum (Al) is connected to positive electrode 1. Lead 9 made of, for example, copper is connected to negative electrode 2.

Electrode group 4 is inserted into battery case 5 in a state in which insulating plates 10a and 10b are placed on the top and bottom parts of electrode group 4, respectively. The end of lead 8 is welded to sealing plate 6, and the end of lead 9 is welded to the bottom part of battery case 5, respectively. Furthermore, a non-aqueous electrolyte (not shown) that conducts lithium ion is filled in battery case 5. In other words, the non-aqueous electrolyte is impregnated into electrode group 4, and interposed between positive electrode 1 and negative electrode 2.

An open end of battery case 5 is caulked with respect to cap 16, current blocking member 18 such as a PTC element, and sealing plate 6 via gasket 7. Cap 16 is provided with vent holes 17 for exhausting gas released when vent mechanism 19 such as a safety valve is opened due to failure occurring in electrode group 4.

Positive electrode 1 includes current collector 1a and positive electrode layer 1b containing positive electrode active material. Positive electrode layer 1b includes a lithium-containing composite oxide such as LiCoO₂, LiNiO₂, and Li₂MnO₄ or a mixture or a composite compound thereof, as the positive electrode active material. Positive electrode layer 1b further includes a conductive agent and a binder. As the conductive agent, graphites such as natural graphites and artificial graphites, or carbon blacks such as acetylene black, Ketjen black, channel black, furnace black, lampblack, thermal black, or the like, can be used. As the binder, for example, polyvinylidene fluoride, polytetrafluoroethylene, polyethylene, polypropylene (PP), aramid resin, polyamide, polyimide, and the like, can be used. As current collector 1a, Al, carbon, conductive resin, or the like, can be used.

As the non-aqueous electrolyte, an electrolyte solution obtained by dissolving a solute in an organic solvent, or a so-called a polymer electrolyte obtained by immobilizing such a solution with a polymer can be used. Examples of the solute of the nonaqueous electrolyte may include LiPF₆, LiBF₄, LiClO₄, LiAlCl₄, LiSbF₆, LiSCN, LiCF₃SO₃, LiN(CF₃CO₂), LiN(CF₃SO₂)₂, and the like. Examples of the organic solvent may include ethylene carbonate, propylene carbonate, butylene carbonate, vinylene carbonate, dimethyl carbonate, diethyl carbonate, ethyl methyl carbonate, and the like.

Negative electrode 2 includes current collector 11 and negative electrode layer 15 containing negative electrode active material. As current collector 11, a metal foil of, for example, stainless steel, nickel, copper, or titanium, a thin film of carbon or conductive resin, or the like, are used. As negative electrode active material contained in negative electrode layer 15, carbon material such as graphite, a material capable of reversibly absorbing and releasing lithium ions and having theoretical capacity density of more than 833 mAh/cm³, like silicon (Si) and tin (Sn), can be used.

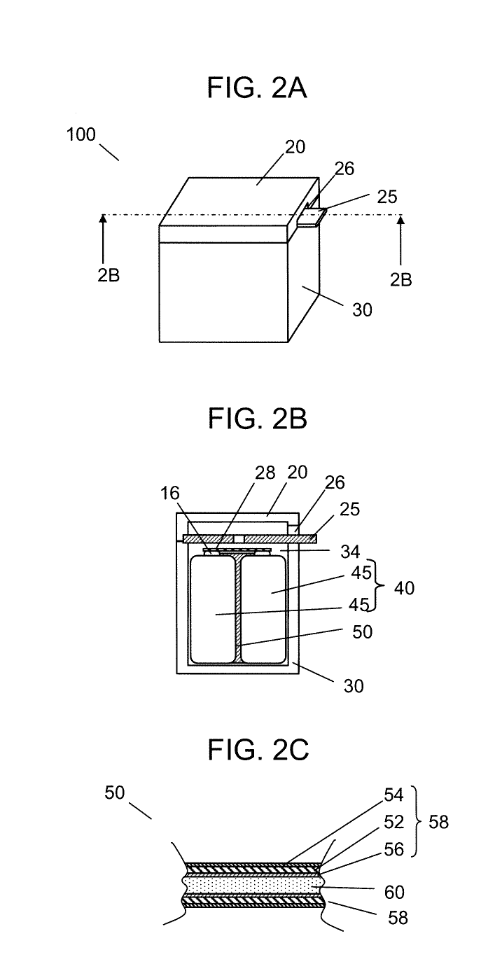

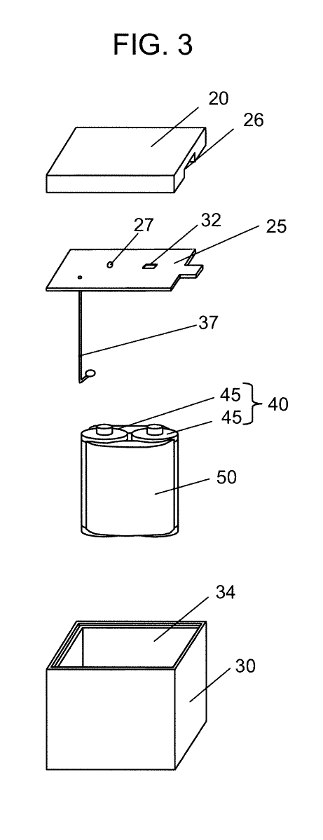

Hereinafter, a battery module in accordance with this exemplary embodiment is described in detail with reference to FIG. 2A to FIG. 5B. FIG. 2A is a perspective view of the battery module in accordance with this exemplary embodiment. FIG. 2B is a sectional view taken along line 2B-2B in FIG. 2A. FIG. 2C is a sectional view showing a principal part of a heat-absorbing member used in the battery module. FIG. 3 is an exploded perspective view of the battery module.

As shown in FIGS. 2A, 2B and 3, battery module 100 includes battery unit 40, housing 30, lid 20 and heat-absorbing member 50. Battery unit 40 includes two or more battery cells 45 each having a vent mechanism. Two battery cells 45 are electrically connected in parallel via connecting plate 28. Housing 30 is made of, for example, an electrically insulating resin material such as polycarbonate resin. Housing 30 includes storage part 34 having an open end at least one surface, and battery unit 40 is stored in storage part 34. Lid 20 having opened part 26 is fitted with housing 30 so as to cover the open end of housing 30. Sheet-like heat-absorbing member 50 is provided in contact with the side surface of battery unit 40.

As shown in FIG. 2C, heat-absorbing member 50 encloses heat-absorbing agent 60 by, for example, fusing two sets of outer films 58. Heat-absorbing material 60 contains liquid such as water as a main component. Gelling agents, surface-active agents, antifreezing agents, or the like, may be added to heat-absorbing agent 60. Gelling agents such as polyvinyl alcohol facilitates the handling of heat-absorbing agent 60. Surface-active agents are added so as to enhance the hydrophilicity. As antifreezing agents, an antifreezing fluid such as ethylene glycol can be used. Addition of such agents is effective. In such a case, the content of liquid such as water in heat-absorbing agent 60 is, for example, about 55 wt % to 99.5 wt %. When water is used as heat-absorbing agent 60, it is preferable that heat-absorbing agent 60 is enclosed in an amount of at least about 2 g per heat-absorbing member 50.

Each outer film 58 includes metal film 52, first resin film 54 and second resin film 56. Metal film 52 is formed of, for example, an Al layer. First resin film 54 is made of, for example, polyethylene terephthalate (PET), and second resin film 56 is made of, for example, polyethylene. First resin film 54 is laminated on a first surface of metal film 52, and second resin film 56 is laminated on a second surface of metal film 52. The thicknesses of metal film 52, first resin film 54, and second resin film 56 are, for example, about 20 μm, 12 μm and 12 μm, respectively.

With such outer film 58, heat-absorbing member 50 has high liquid penetration resistance such that leakage of heat-absorbing agent 60 is prevented even when it is stored at 85° C. for 30 days, and heat-absorbing member 50 is not ruptured even if an external pressure (70 kgf/sheet) is applied. That is to say, with the laminate structure of heat-absorbing member 50, a battery module capable of stably holding heat-absorbing agent 60 and having safety over a long time can be achieved. Note here that material enclosing heat-absorbing agent 60 may be material containing resin as a main component as long as it satisfies the liquid penetration resistance.

Then, after connecting board 25 is connected to battery unit 40, battery unit 40 is stored in a substantially sealed space formed by storage part 34 of housing 30 and connecting board 25, and lid 20 is fitted therewith. Thus, battery module 100 is completed.

Hereinafter, each component constituting battery module 100 is described with reference to the drawings.

As shown in FIG. 3, housing 30 has an open end on the side with which lid 20 is fitted, and has storage part 34 in which battery unit 40 can be stored from the open end. When battery cell 45 has a size of, for example, outer diameter of 18 mm and height of 65 mm, housing 30 has height of 65 mm plus a thickness of connecting plate 28 for coupling caps 16. As shown in FIG. 3, lid 20 is provided with opened part 26 in a part of the peripheral wall.

Connecting board 25 is formed of, for example, a glass-epoxy substrate. Connecting board 25 has connection terminal 32 connected with a first electrode (for example, a positive electrode) at the vent mechanism side of each battery unit 40, connecting plate 37 connected to a second electrode (for example, a negative electrode), and through hole 27. Connection terminal 32 and connecting plate 37 are formed of, for example, a nickel plate, a lead wire, or the like. Note here that instead of forming electrical connection between battery unit 40 and the outside of housing 30 by using connecting board 25, the positive electrode and the negative electrode may be led out directly to the outside. In this case, a communication space corresponding to through hole 27 of connecting board 25 is preferably provided.

Battery unit 40 includes at least two or more battery cells 45 integrated with each other, and is provided with heat-absorbing member 50 that is in contact with the side surface of the battery unit 40. It is preferable that heat-absorbing member 50 is provided on the side surface facing vent hole 17 of battery cell 45. Furthermore, it is preferable that the end portion of heat-absorbing member 50 is exposed from the side surface of battery cell 45 to the height of vent hole 17 of battery cell 45. Thus, heat-absorbing member 50 can be securely unsealed, so that heat-absorbing agent 60 can be discharged toward each battery cell 45.

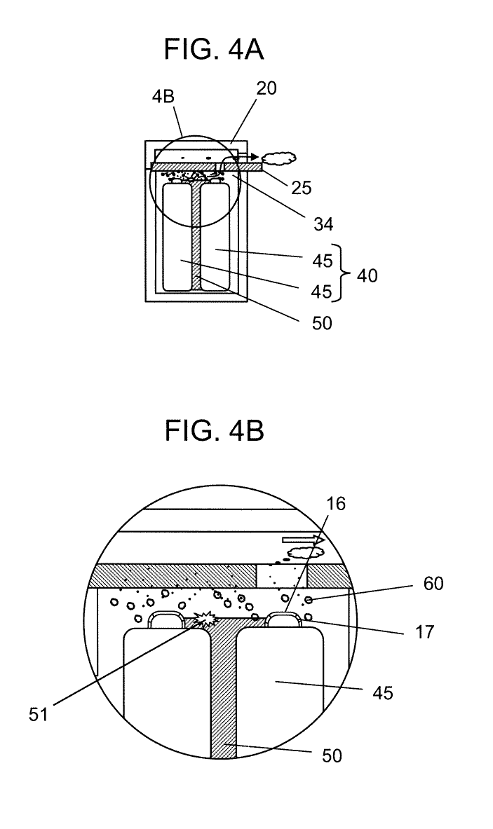

Hereinafter, an operation and an effect of heat-absorbing member 50 and exhaustion of gas discharged when abnormal heat generation and the like occurs in one of battery cells 45 in battery module 100 are described with reference to FIGS. 4A and 4B. FIG. 4A is a sectional view illustrating a state in which abnormal heat generation occurs in one of battery cells 45 of battery unit 40 in battery module 100, and FIG. 4B is an enlarged sectional view of part 4B in FIG. 4A.

Firstly, as shown in FIG. 4B, when abnormal heat generation occurs in one of battery cells 45, a pressure in case 5 shown in FIG. 1 is increased due to gas generated inside battery unit 45, vent mechanism 19 works and gas is discharged from vent hole 17 of cap 16. Then, the gas is discharged from vent hole 17 into storage part 34 formed by connecting board 25 and housing 30. At this time, when the gas is rapidly discharged from battery cell 45, in general, the gas easily ignites and catches fire.

With this fire, part 51 of heat-absorbing member 50 is broken (unsealed), and heat-absorbing agent 60 is ejected from the inside of heat-absorbing member 50 into storage part 34 and attached to battery cell 45. Furthermore, the attached heat-absorbing agent 60 is vaporized by heated battery cell 45 or fire. Since heat-absorbing agent 60 absorbs evaporation latent heat while it is vaporized, it lowers the temperature of battery cell 45 and extinguishes a fire to allow the fire to return to the state of the discharged gas. Specifically, when heat-absorbing agent 60 contains water as a main component, the evaporation latent heat of 1 g of water is about 560 cal. Accordingly, heat-absorbing agent 60 can lower the temperature of battery cell 45 that is a lithium ion battery having the above-mentioned size by about 37° C. In this way, when heat-absorbing agent 60 contains water as a main component, the temperature of battery cell 45 with failure can be effectively lowered by large evaporation latent heat of water. In the above description, an example in which part 51 of heat-absorbing member 50 is unsealed with a fire is described, but not limited to this example. For example, heat-absorbing agent 60 may be released by the internal pressure that is increased when the air inside of heat-absorbing member 50 or heat-absorbing agent 60 expands by abnormally generated heat of battery cell 45.

In this way, heat-absorbing agent 60 can lower the temperature of abnormally heated battery cell 45, and remarkably reduce heat transfer to the surrounding battery cells 45. As a result, it is possible to prevent successive heating and the like due to heat transfer in battery unit 40, and to minimize failure of battery module 100. Furthermore, heat-absorbing agent 60 released from heat-absorbing member 50 cools the high-temperature gas discharged from battery cell 45 to a temperature that is not higher than its firing point while it is exhausted from battery module 100. As a result, by preventing the occurrence of fire due to ignition of gas, the gas discharged from battery cell 45 can be exhausted as it is from battery module 100.

In this way, when liquid or gel fluid is used as heat-absorbing agent 60, heat generation and/or ignition can be prevented with a small amount of heat-absorbing agent 60. As a result, a battery module having a smaller size, higher safety and more excellent reliability can be achieved.

Furthermore, since heat-absorbing member 50 is provided in a sheet form, heat-absorbing member 50 can be in contact with each of battery cells 45 constituting battery unit 40 in a wider area. Therefore, it is possible to reduce the temperature rise due to abnormal heat generation of battery cell 45 with failure efficiently.

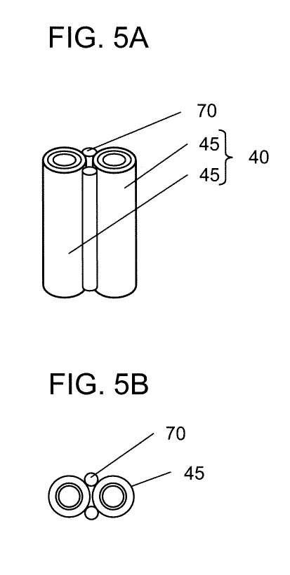

In this exemplary embodiment, sheet-shaped heat-absorbing member 50 is described as an example, but the shape is not limited to this. For example, as shown in FIGS. 5A and 5B, cylindrical heat-absorbing member 70 may be disposed in contact with the side surface of each battery cell 45. FIGS. 5A and 5B are a perspective view and a top view of another battery unit in accordance with this exemplary embodiment. That is to say, cylindrical heat-absorbing member 70 may be provided in contact with the side surface of each battery cell 45 between battery cells 45. Note here that it is preferable that a concave portion is provided on the side wall or the inner bottom surface of housing 30 in order to determine the position of heat-absorbing member 70.

In this configuration, since the heat-absorbing member need not be provided so as to cover the outer peripheral side surface of battery unit 40, battery module 100 can be further reduced in size. Furthermore, in a case that heat-absorbing member 70 is fitted with the concave portion of housing 30, an assembling property or workability can be improved. Note here that the shape of heat-absorbing member 70 is not limited to a cylindrical shape, but any shapes can be employed as long as they can be inserted into a space between battery cells 45.

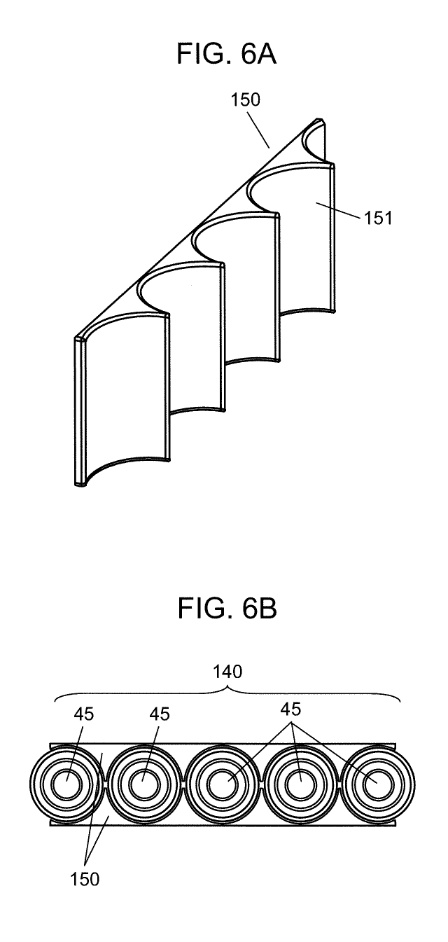

Furthermore, it is preferable that the heat-absorbing member is formed so that it corresponds to the side surface of the battery cells constituting a battery unit as much as possible. Heat-absorbing member 150 having such a shape is described with reference to FIGS. 6A and 6B. FIG. 6A is a perspective view of a heat-absorbing member used in another battery unit in accordance with the first exemplary embodiment of the present invention; and FIG. 6B is a top view of the battery unit using the heat-absorbing member shown in FIG. 6A.

Heat-absorbing member 150 has a plurality of cylindrical surfaces 151 corresponding to the side surfaces of battery cells 45 constituting a battery unit. Battery unit 140 including a plurality of battery cells 45 arranged in a line is sandwiched by two heat-absorbing members 150. Heat-absorbing member 150 has a larger contact area with each battery cell 45 as compared with heat-absorbing member 50 shown in FIG. 3A and heat-absorbing member 70 shown in FIG. 5A. Thus, when heat generation occurs in one of battery cells 45, heat-absorbing member 150 is susceptible to the heat. Therefore, a part of heat-absorbing member 150 is opened (unsealed) more reliably, and the heat-absorbing agent inside is ejected onto battery cell 45 that generates heat.

Heat-absorbing member 150 can be formed, for example, by thermally fusing a portion constituting cylindrical surfaces 151 and upper and lower surfaces to a portion constituting a back part. The portion constituting cylindrical surfaces 151 and upper and lower surfaces can be formed by vacuum molding PP, polyethylene resin, or the like. The portion constituting the back surface can be formed of PP-laminated Al foil. Then, the portion constituting cylindrical surfaces 151 and upper and lower surfaces is placed with cylindrical surfaces 151 facing downward, liquid heat-absorbing agent is infused into the rear side of cylindrical surfaces 151, and the PP laminated to the Al foil is thermally fused thereto.

In this configuration, it is preferable that the portion constituting cylindrical surfaces 151 and upper and lower surfaces is thermally welded to the portion constituting the back part only in the outer peripheral part. Thus, the inner spaces of heat-absorbing member 150 communicate to each other. Therefore, the heat-absorbing agent may be enclosed in heat-absorbing member 150 in an amount capable of lowering the temperature of one of battery cell 45 with failure.

FIG. 6B shows an example in which five battery cells 45 constitute battery unit 140, but the number of battery cells 45 constituting battery unit 140 is not limited. Furthermore, cylindrical battery cell 45 is described as an example, but a battery unit may be configured by using rectangular battery cells. That is to say, it is preferable that the heat-absorbing member has a plurality of surfaces having a shape similar to that of a side surface of each of the battery cells constituting the battery unit.

### Second Exemplary Embodiment

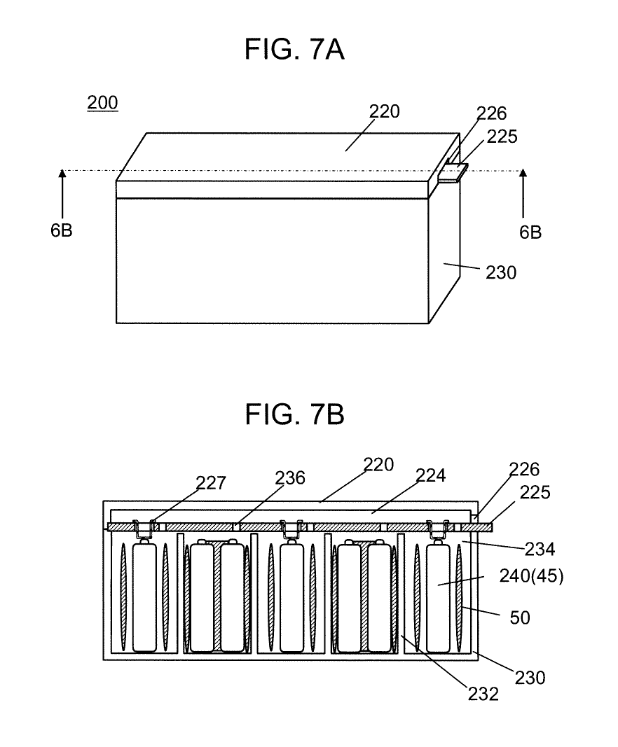

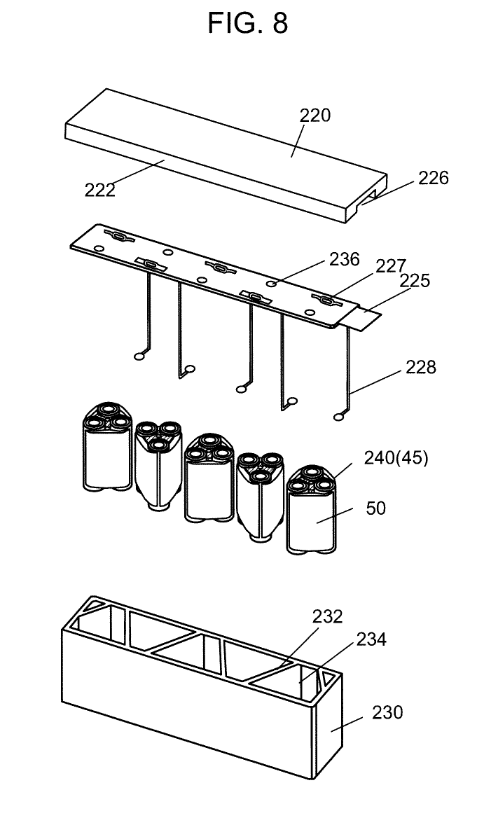

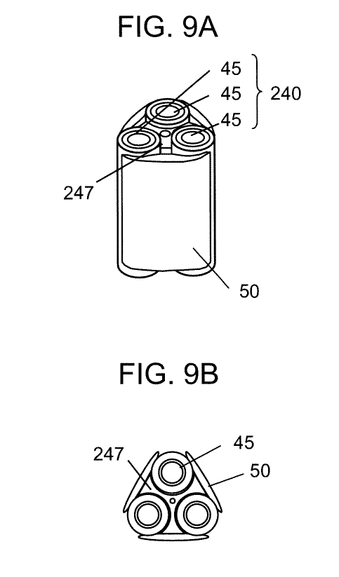

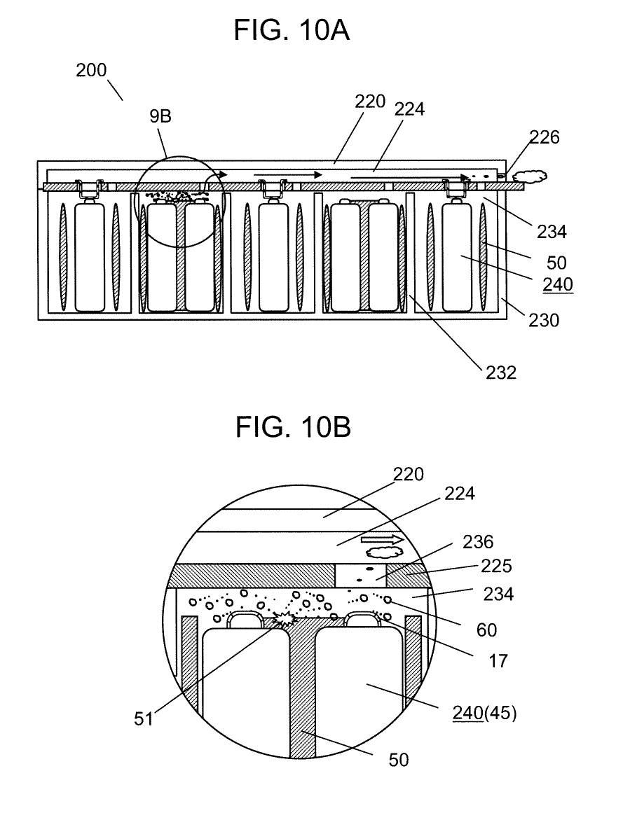

A battery module in accordance with a second exemplary embodiment of the present invention is described in detail with reference to FIGS. 7A to 10B. FIG. 7A is a perspective view of a battery module in accordance with this exemplary embodiment, and FIG. 7B is a sectional view taken along line 6B-6B in FIG. 7A. FIG. 8 is an exploded perspective view of the battery module. FIGS. 9A and 9B are a perspective view and a top view of a battery unit used in the battery module. FIG. 10A is a sectional view illustrating a state in which abnormal heat generation occurs in one of battery cells of one of battery units in the battery module, and FIG. 10B is an enlarged sectional view of part 9B in FIG. 10A.

As shown in FIGS. 7B and 8, battery module 200 is different from battery module 100 of the first exemplary embodiment in that a plurality of storage parts 234 are provided by partition walls 232 in housing 230 of battery module 200, and each battery unit 240 is stored in respective one of storage parts 234. In this exemplary embodiment, battery unit 240 having a configuration in which three battery cells 45 are integrated together is described as an example. Furthermore, in this exemplary embodiment, an example in which battery units 240 are connected to each other via wiring board 225 is described, but, similar to the first exemplary embodiment, the battery units may be connected to each other via a connecting board.

As shown in FIGS. 7A to 8, battery module 200 includes housing 230 lid 220 fitted with housing 230, both made of, for example, insulating resin material such as polycarbonate resin. A plurality of battery units 240 electrically connected to wiring board 225 are stored in housing 230. Sheet-shaped heat-absorbing member 50 enclosing heat-absorbing agent is provided in contact with the side surface of each battery unit 240. Each battery unit 240 is stored in a space formed by wiring board 225 and each storage part 234 of housing 230. As mentioned below, this space communicates to an outside space through opened part 226 via through hole 236 formed in wiring board 225 and exhaust chamber 224 formed in lid 220.

Next, each component constituting battery module 200 is described with reference to FIG. 8. Housing 230 has an open end on the side where housing 230 is fitted with lid 220. Housing 230 has a plurality of storage parts 234 partitioned by partition walls 232. Each battery unit 240 is individually installed into respect one of storage parts 234 from the above-mentioned open end. In the case that each battery cell 45 of battery unit 240 has, for example, outer diameter of 18 mm and height of 65 mm, the height of partition wall 232 is about 65 mm plus a protruding height of the below-mentioned connection terminal 227 from wiring board 225.

Lid 220 has peripheral wall 222. Peripheral wall 222 forms exhaust chamber 224 shown in FIG. 7B. Furthermore, peripheral wall 222 is provided with opened part 226 in its part.

In battery unit 240, as shown in FIGS. 9A and 9B, for example, three battery cells 45 are integrated together and heat-absorbing member 50 is provided in contact with the side surface of each battery unit 45. It is preferable that each battery cell 45 is maintained in a predetermined position by using spacer 247. When spacer 247 is used, each battery cell 45 can be separated from each other, so that heat transfer between battery cells 45 can be suppressed. Also from this viewpoint, it is preferable that spacer 247 is used. Furthermore, as shown in FIG. 10B, it is preferable that heat-absorbing member 50 is provided on the side surface facing vent holes 17 of battery cells 45. Furthermore, it is preferable that the end portion of heat-absorbing member 50 is exposed from the side surface of battery cell 45 to the height of vent hole 17 of battery cell 45. These advantages are the same as those in the first exemplary embodiment.

As shown in FIG. 8, wiring board 225 is formed of, for example, a glass-epoxy substrate. Wiring board 225 includes connection terminals 227, connecting plates 228, through holes 236 and power supply wirings (power lines: not shown). Each of connection terminals 227 is connected to a first electrode (for example, a positive electrode) at the vent mechanism side of battery cells 45 constituting each battery unit 240. Each of connecting plates 228 is connected to a second electrode (for example, a negative electrode). Each of the power supply wirings connects at least neighboring connection terminal 227 and connecting plate 228 to each other. Connection terminals 227 and connecting plates 228 are formed of, for example, a nickel plate, a lead wire, or the like, and connected to respective one of the power supply wirings formed of, for example, copper foil on wiring board 225, via, for example, solder.

Each through hole 236 is provided at a position facing perspective one of battery units 240 and in a region on wiring board 225, the region is different from the portion where connection terminal 227 is provided. As shown in FIG. 7B, each connection terminal 227 is provided such that it protrudes in the thickness direction of wiring board 225, and electrically connected to a first electrode of each battery unit 240 by, for example, spot welding. Thus, since battery units 240 can be connected to each other via wiring board 225, a space necessary for routing power supply wirings, control wirings, and the like, can be remarkably reduced. Therefore, it is not necessary to provide a clearance space or a through hole in partition walls 232 that form storage parts 234. Consequently, each of battery units 240 can be stored in respective one of storage parts 234 formed by partition walls 232 and wiring board 225 in such a manner that battery units 240 are separated from each other so as not to cause thermal effect on each other. In other words, gas discharged from a battery unit in an abnormal state cannot enter the storage part of an adjacent battery unit. Therefore, even if the gas ignites and catches fire, entry of the fire is prevented, and the influence thereof can be inhibited reliably.

Next, an operation and an effect of heat-absorbing member 50 when abnormal heat generation and the like occurs in one of battery cells 45 constituting battery unit 240 in battery module 200 are described with reference to FIGS. 10A and 10B.

As shown in FIG. 10B, when one of battery cells 45 abnormally generates heat, gas is discharged from vent hole 17 in cap 16 as described in the first exemplary embodiment. The gas is discharged into storage part 234 formed by wiring board 225 and partition wall 232 of housing 230. At this time, air and/or heat-absorbing agent 60 in heat-absorbing member 50 provided in contact with battery cell 45 are also heated simultaneously, and heat-absorbing member 50 swells due to the increase in the internal pressure.

When the internal pressure is increased to not less than the adhesive strength for sealing heat-absorbing member 50, part 51 of heat-absorbing member 50 is unsealed (opened). Then, heat-absorbing agent 60 is ejected from the inside into storage part 234 of housing 230 and floats therein, and is attached to battery cells 45. Furthermore, attached heat-absorbing agent 60 vaporizes by heated battery cell 45. At this time, when heat-absorbing agent 60 vaporizes, with evaporation latent heat, the temperature of battery cell 45 with failure is lowered and the temperature of gas discharged from battery cell 45 is also lowered.

In the above description, an example in which a part of heat-absorbing member 50 is unsealed due to the increase of the internal pressure by heating is described, but not limited thereto. As mentioned above, when heat-absorbing member 50 is formed by using outer films mainly including resin material, if heat generation occurs in any one of battery cells 45, a part softened by the heat expands and is ruptured by the internal pressure of heat-absorbing member 50. Alternatively, the part is melted and ruptured. Furthermore, even when metal film 52 shown in FIG. 2C is formed of Al foil, if battery cell 45 is heated to 700 to 800° C., heat-absorbing member 50 is ruptured by the same mechanism. This is because the melting point of Al is about 660° C.

In this way, it is preferable that outer film 58 of heat-absorbing member 50 is formed with strength such that outer film 58 is melted by the heat generation of one of battery cells 45 or outer film 58 is ruptured by the increase of the internal pressure when the strength is lowered. Thus, outer film 58 is broken in a portion in which the largest temperature rise occurs, and heat-absorbing agent 60 is ejected onto a battery cell whose temperature is to be lowered. Note here that such a configuration may be applied to the first exemplary embodiment.

Furthermore, when heat-absorbing member 50 is configured in such manners, heat-absorbing agent 60 can be ejected even if each battery cell 45 does not have a vent mechanism. Needless to say, when each battery cell 45 has a vent mechanism, similar to the first exemplary embodiment, heat-absorbing member 50 may be unsealed due to a fire occurring by the ignition of discharged gas, for example. Also from the viewpoint of the safety of battery cell 45 itself, it is more preferable that each battery cell 45 has a vent mechanism.

In this way, heat-absorbing agent 60 lowers the temperature of abnormally heated battery cell 45, and remarkably reduces the heat transfer to surrounding battery cells 45. As a result, successive heat generation due to heat transfer inside of each battery unit 240 can be prevented, thus minimizing failure of battery module 200.

Furthermore, battery module 200 has a limited amount of oxygen in storage part 234 and storage part 234 is a substantially sealed space in which oxygen is not supplied from the outside. Consequently, there is an extremely low possibility that the discharged gas catches fire. However, as shown in FIG. 10A, the discharged gas is exhausted from opened part 226 via exhaust chamber 224 of lid 220, so that it may be reacted with oxygen in the outside air to catch fire.

In this exemplary embodiment, during exhaustion of the discharged gas, heat-absorbing agent 60 released from heat-absorbing member 50 lowers the temperature of the gas to not higher than the firing point of the gas. As a result, gas in storage part 234 that stores battery cell 45 with failure or gas exhausted to the outside does not cause explosive expansion due to ignition and is exhausted in a state of the gas. Consequently, it is possible to prevent ignition of the gas exhausted from opened part 226 effectively, and to prevent a rupture of battery module 200 reliably.

Furthermore, partition walls 232 of housing 230 prevent heat of abnormally heated battery unit 240 from being transferred to adjacent battery units 240. As a result, it is possible to remarkably suppress the influence by the heat transfer from storage part 234 that stores abnormally heated battery unit 240 to battery units 240 stored in other storage parts 234.

In the above description, as an example of wiring board 225, a glass-epoxy substrate is described, but not limited thereto. For example, wiring board 225 may be composed of a flexible wiring board and a reinforcing member attached to the flexible substrate. The wiring board has a configuration in which power supply wirings (not shown) made of, for example, copper foil, and control wirings (not shown) is sandwiched by polyimide resin, PET, or the like. Connection terminal 227 connected with a first electrode of battery unit 240 is preferably formed in a state in which a nickel plate or the like is exposed by considering spot welding. As the reinforcing member, polyphenylene sulfide (PPS) resin, polycarbonate (PC) resin, polyether ether ketone (PEEK) resin, phenol resin, UNILATE, glass epoxy resin, ceramic, or the like, can be used.

Note here that these resins may contain filler such as carbon fiber and glass fiber. Furthermore, wiring board 225 may be formed by insert-molding a bus bar and the like into the same material as that of the reinforcing member. Thus, it is possible to enhance the mechanical strength of wiring board 225, and to improve deformation resistance and/or heat resistance of wiring board 225 with respect to the pressure of the discharged gas. Therefore, it is possible to enhance the reliability and safety.

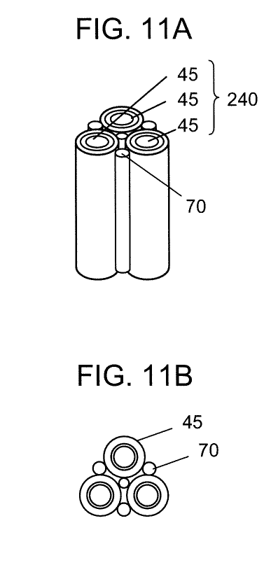

Furthermore, in this exemplary embodiment, a sheet-shaped heat-absorbing member 50 is described as an example, but heat-absorbing member 50 is not limited to this shape. Similar to the first exemplary embodiment, as shown in FIG. 11A and FIG. 11B, cylindrical heat-absorbing member 70 may be disposed in contact with the side surface of each battery cell 45. FIG. 11A and FIG. 11B are a perspective view and a top view of another battery unit in this exemplary embodiment. In this configuration, cylindrical heat-absorbing members 70 are provided between battery cells 45 of each battery unit 240 so that they are provided in contact with the side surfaces of battery cells 45. Meanwhile, in order to determine the position of heat-absorbing member 70, it is preferable that housing 230 is provided with concave portions (not shown).

In this configuration, since the heat-absorbing member need not be provided so as to cover the outer peripheral side surface of each battery unit 240, battery module 200 can be further reduced in size. Furthermore, by fitting heat-absorbing members 70 into concave portions of housing 230, an assembly property and workability can be improved.

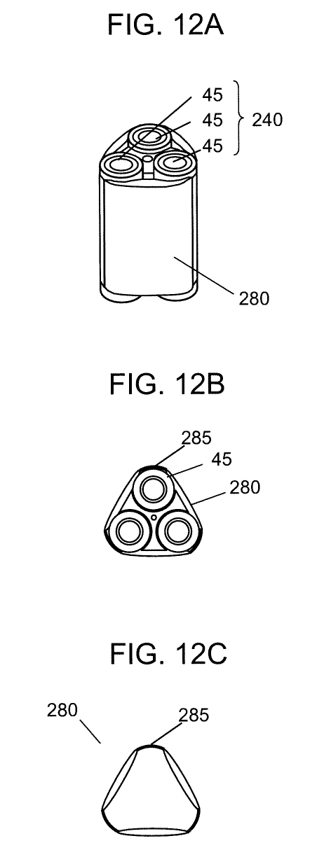

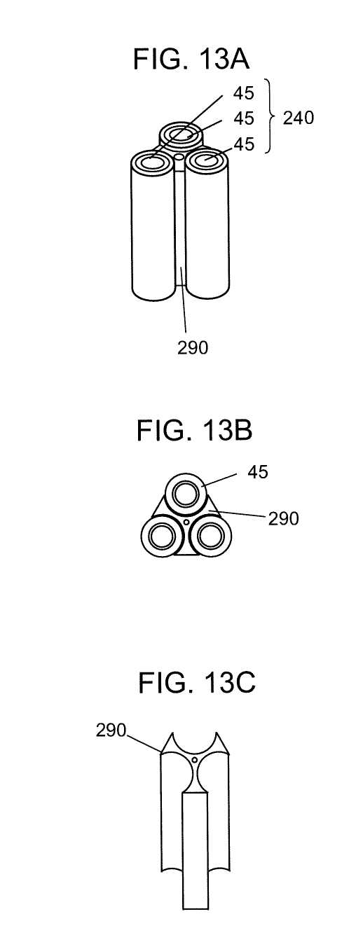

Next, another example of a heat-absorbing member used in a battery unit in this exemplary embodiment is described with reference to FIGS. 12A to 13C. FIGS. 12A and 12B are a perspective view and a top view of still another battery unit in this exemplary embodiment. FIG. 12C is a top view of a heat-absorbing member used in this battery unit. FIGS. 13A and 13B are a perspective view and a top view of yet another battery unit in this exemplary embodiment, respectively. FIG. 13C is a perspective view of a spacer used in this battery unit.

In the configuration shown in FIGS. 12A to 12C, heat-absorbing member 280 is configured so that it is in close contact with the outer peripheral shape of battery unit 240. For example, heat-absorbing member 280 may be configured by integrating three heat-absorbing members together. Thus, workability and assembly property are remarkably improved. In this case, it is preferable that heat-absorbing members are integrated with each other by using member 285 having elasticity made of, for example, elastic rubber. Thus, a secure contact state between each battery cell 45 and respective two of heat-absorbing members 280 can be maintained reliably.

In the configuration shown in FIGS. 13A to 13C, spacer 290 is allowed to enclose heat-absorbing agent therein, so that spacer 290 is used also as the heat-absorbing member. Spacer 290 can be formed in a hollow state by, for example, blow molding, followed by injecting heat-absorbing agent such as water, and sealing the injection hole by, for example, thermal fusion.

Thus, battery cells 45 constituting battery unit 240 can be disposed in such a manner that they are positioned in predetermined positions and intervals. Furthermore, one spacer 290 can be disposed in contact with all battery cells 45 of battery unit 240. Therefore, spacer 290 can cope with failure occurring in any of battery cells 45 of battery unit 240. Since spacer 290 encloses only a heat-absorbing agent in an amount capable of lowering the temperature of one battery cell 45 with failure, the total amount of the heat-absorbing agent can be remarkably reduced as compared with the configuration shown in, for example, FIG. 9A. Thus, battery module 200 can be further reduced in size.

### Third Exemplary Embodiment

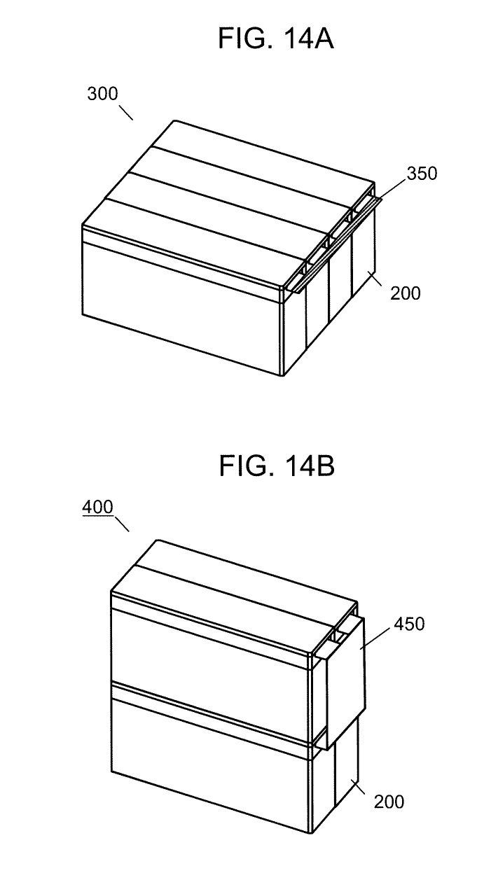

Hereinafter, a battery module assembly in accordance with a third exemplary embodiment of the present invention is described with reference to FIGS. 14A and 14B. FIGS. 14A and 14B are perspective views of a battery module assembly in this exemplary embodiment.

Battery module assembly 300 shown in FIG. 14A has a configuration in which four battery modules 200 of the second exemplary embodiment are arranged horizontally and connected by connection member 350. Furthermore, battery module assembly 400 shown in FIG. 14B has a configuration in which two battery modules 200 are arranged horizontally to form a pair body, two of the pair bodies are piled vertically, and they are connected by connection member 450. That is to say, battery modules 300 and 400 are configured by connecting a plurality of battery modules 200 in parallel or in series, or in combination of parallel connection and serial connection via connection member 350 or 450.

In this way, by arbitrarily combining highly versatile battery modules 200 depending upon the applications of use with an arrangement space taken into consideration, it is possible to easily achieve a battery module assembly having necessary voltage and electric capacity.

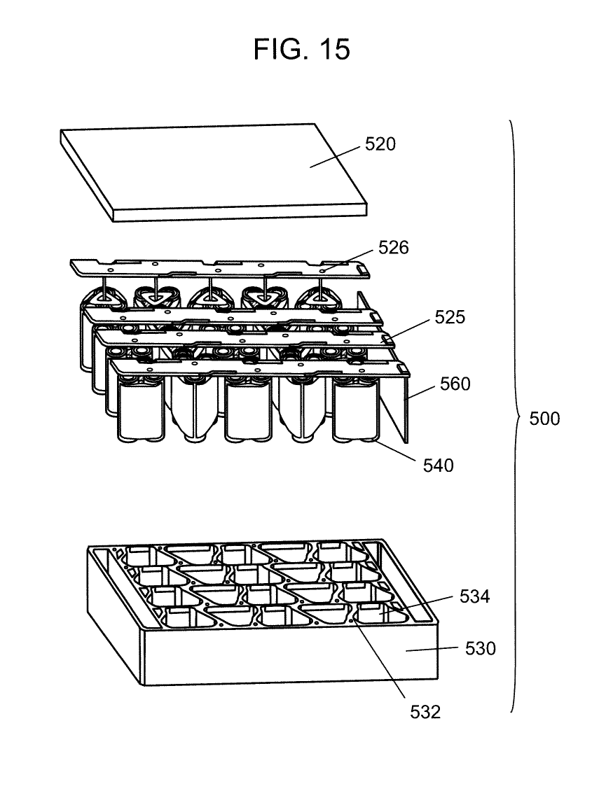

Next, another battery module assembly in this exemplary embodiment is described with reference to FIG. 15. FIG. 15 is an exploded perspective view of another battery module assembly in accordance with this exemplary embodiment. Battery module assembly 500 is different from that of the first and second exemplary embodiments in that a plurality of battery units 540 are integrally stored in two-dimensional arrangement.

Battery module assembly 500 includes housing 530, a plurality of battery units 540, a plurality of wiring boards 525, ECU (Electric Control Unit) 560, and lid 520. Housing 530 includes storage parts 534 two-dimensionally partitioned with partition walls 532. Each battery unit 540 is stored in respective one of storage parts 534.

Each wiring board 525 connects battery units 540 one-dimensionally. Each wiring board 525 detects temperatures and/or voltages of battery cells and controls them, and transmits/receives information with respect to external apparatuses. Furthermore, each wiring board 525 is provided with through holes 526 in positions facing vent mechanisms of the battery cells of each battery unit 540. ECU 560 connects wiring boards 525 in parallel and/or in series.

Lid 520 is fitted with housing 530 so as to seal battery units 540 and wiring boards 525 in substantially a sealed state. Lid 520 includes an exhaust chamber (not shown) and also has opened parts (not shown) for exhausting the discharged gas such that each opened part corresponds to, for example, respect one of wiring boards 525. By integrating housing 530 as mentioned above, it is possible to achieve battery module assembly 500 that is further reduced in size.

Note here that in each exemplary embodiment, a control circuit for detecting and controlling charge and discharge, temperatures and/or voltages of the battery module is not particularly described and not shown in the drawings, but the control circuit may be provided in the outside or inside of the battery module.

Furthermore, each exemplary embodiment describes an example in which a battery unit includes cylindrical battery cells, but not limited thereto. For example, a rectangular battery cell may be employed. Furthermore, a battery cell having a positive electrode terminal, a negative electrode terminal and a vent mechanism on the same side may be employed. Thus, an assembly property of each battery unit and a wiring board and workability are remarkably improved.

In each exemplary embodiment, the configurations can be mutually employed.

### INDUSTRIAL APPLICABILITY

The present invention is useful as battery modules and battery module assemblies used in, for example, automobiles, bicycles, electrical power tools, and the like, which require high reliability and high safety.

1. A battery module comprising:
a battery unit including two or more battery cells;
a housing including a storage part having an open end on at least one surface, the storage part storing the battery unit;
a lid having an opened part and covering the open end of the housing; and
a heat-absorbing member which includes heat-absorbing agent made of liquid or gel fluid, and an outer film enclosing the heat-absorbing agent, the heat-absorbing member being in contact with a side surface of the battery unit,
wherein the outer film of the heat-absorbing member has a laminated structure composed of a metal film and a resin layer.

2. The battery module according to claim 1,
wherein the battery unit is one of a plurality of battery units,
the housing has partition walls to form a plurality of the storage parts, and
each of the battery units is stored in each of the storage parts.

3. The battery module according to claim 1,
further comprising a wiring board disposed between the housing and the lid and covering the open end of the housing,
wherein each of the battery cells has a vent mechanism,
the wiring board is provided at the vent mechanism side of each of the battery cells constituting the battery unit, has a connection terminal connected to the battery unit, and is provided with a through hole formed at a position that is in a different region from a region of the connection terminal and faces the battery unit.

4. The battery module according to claim 1,
wherein the heat-absorbing agent contains water as a main component.

5. The battery module according to claim 1,
wherein the resin layer is one of resin layers in the outer film of the heat-absorbing member, and the resin layers are formed on both surfaces of the metal film.

6. The battery module according to claim 1,
wherein the heat-absorbing member has a sheet shape.

7. The battery module according to claim 1,
wherein the heat-absorbing member has a cylindrical shape.

8. The battery module according to claim 1,
further comprising a spacer interposed between the battery cells of the battery unit.

9. The battery module according to claim 1,
wherein the heat-absorbing member functions as a spacer interposed between the battery cells of the battery unit.

10. The battery module according to claim 1,
wherein the heat-absorbing member has a plurality of surfaces having a shape similar to that of a side surface of each of the battery cells constituting the battery unit.

11. A battery module assembly comprising:
a plurality of battery modules; and
a connecting member for combining and connecting the plurality of battery modules at least one of in series and in parallel,
wherein each of the plurality of battery modules comprise:
a battery unit including two or more battery cells;
a housing including a storage part having an open end on at least one surface, the storage part storing the battery unit;
a lid having an opened part and covering the open end of the housing; and
a heat-absorbing member which includes heat-absorbing agent made of liquid or gel fluid, and an outer film enclosing the heat-absorbing agent, the heat-absorbing member being in contact with a side surface of the battery unit,
wherein the outer film of the heat-absorbing member has a laminated structure composed of a metal film and a resin layer.
